(19) United States
(12) Patent Application Publication
(10) Pub. No.: US 2006/0221272 A1
(43) Pub. Date: Oct. 5, 2006

(54) Light emitting diode backlighting systems and methods that use more colors than display picture elements

(76) Inventors: Gerald H. Negley, Hillsborough, NC (US); Antony P. van de Ven, Sai Kung (HK)

Correspondence Address: MYERS BIGEL SIBLEY & SAJOVEC, PO BOX 37428, RALEIGH, NC, 27627, US

(21) Appl. No.: 11/098,126

(22) Filed: Apr. 4, 2005

(51) Int. Cl. G02F 1/1335

(52) U.S. Cl. 349/64

(57) ABSTRACT

Backlight systems for display screens include multiple arrays of multiple different color picture elements and multiple arrays of LED devices that are configured to radiate light of multiple colors in a light path that impinges on the display screen, to provide backlighting on the display screen. More arrays of different color LED devices than arrays of different color picture elements are provided. For example, red, green and blue color picture elements may be provided, whereas red, green, blue and cyanine and/or amber backlighting LED devices may be provided.

### FIELD OF THE INVENTION

This invention relates to displays such as Liquid Crystal Displays (LCDs), and more particularly, to backlighting of displays, such as LCDs.

### BACKGROUND OF THE INVENTION

Display screens are widely used for computer monitors, televisions and many other display applications. Some flat panel display screens include an array of optical shutters and a backlight system that impinges light on the display screen.

For example, LCD devices are widely used in flat panel displays for monitors, televisions and/or other display applications. As is well known to those having skill in the art, an LCD display generally includes an array of LCD devices that act as an array of optical shutters. Transmissive LCD displays employ backlighting using, for example, fluorescent cold cathode tubes above, beside and sometimes behind the array of LCD devices. A diffusion panel behind the LCD devices can be used to redirect and scatter the light evenly to provide a more uniform display.

Conventional shuttered display devices generally include three different color picture elements (often referred to as pixels and/or subpixels), generally red (R), green (G) and blue (B) picture elements. A backlight system for shuttered display devices may be configured to uniformly radiate light on the display screen that is perceived as white light. As used herein, “different colors” means different frequency spectra having different center frequencies.

As is well known to those having skill in the art, the combination of red, green and blue picture elements define a gamut of colors or color gamut, which is that portion of the visible color space that can be represented by the display. The visible color space and a color gamut therein are generally represented in an x-y chromaticity diagram. It may be desirable to change the color gamut of a display.

As is also well known to those having skill in the art, a Color Rendition Index (CRI) is a measure of how a light influences the color appearance of objects that are being illuminated. It represents an ability of a light source to render color accurately, and to show color shade variations more clearly. High color rendition allows one to see objects as one would expect them to appear under natural sunlight. Color rendition is measured via a complex process on the color rendition index scale ranging in value from 0 to 100. It may be desirable to change the color rendition index of a display.

### SUMMARY OF THE INVENTION

Some embodiments of the invention provide backlight systems for display screens that include a plurality of arrays of a respective plurality of different color picture elements. A plurality of arrays of LED devices are configured to radiate light of a respective plurality of different colors in a light path that impinges on the display screen to provide backlighting on the display screen. More arrays of different color LED devices than arrays of different color picture elements are provided.

In some embodiments, three different color picture elements and four different color LED devices are provided. The four different color LED devices can be configured to create a perception of white light. In some embodiments, the display screen comprises a two-dimensional array of LCD devices including three color filters thereon.

In some embodiments, the two-dimensional array of LCD devices includes red, blue and green color filters thereon and does not include a cyanine (also referred to as cyan) color filter thereon, and the four different color LED devices include arrays of red, green, blue and cyanine LED devices. In still other embodiments of the invention, the two-dimensional array of LCD devices includes red, blue and green filters thereon and does not include cyanine or amber (yellow) color filters thereon, and the different color LED devices include arrays of red, green, blue, cyanine and amber LED devices.

It will be understood by those having skill in the art that embodiments of the present invention have been described above in terms of backlight systems for display screens and display screens including backlight systems. However, other embodiments of the present invention provide analogous methods of operating a display screen that includes a two-dimensional array of LCD devices and three different color filters thereon, and three arrays of LED devices that are configured to radiate light of a respective three different colors in a light path that impinges on the display screen to provide backlighting that is perceived as white light on the display screen. These methods may include adding at least a fourth array of LED devices that is configured to radiate light in a fourth color that is different from the three colors, to continue to provide backlighting that is perceived as white light on the display screen. The fourth array may include cyanine and/or amber LED devices. Moreover, system and/or method embodiments of the invention may be used with arrays of backlighting light sources other than LEDs, such as field emitter/phosphor arrays.

Yet other embodiments of the present invention provide backlighting methods for a display screen that includes picture elements of different colors, by backlighting the display screen with more different colors than the picture elements. As was described above, backlighting may be performed with red, green, blue, and cyanine and/or amber colors. In some embodiments, these more different colors may be provided by a plurality of light sources of more different colors than the picture elements. Moreover, in some embodiments, the backlighting of the display screen with more different colors may provide backlighting that is perceived as white light on the display screen. Analogous backlight system embodiments for a display screen that includes picture elements of different colors can provide at least one light source that is configured to radiate light of more different colors than the picture elements in a light path that impinges on the display screen, to provide backlighting on the display screen. The at least one light source can provide red, green, blue and cyanine and/or amber colors that is perceived as white light, as was described above.

Still other embodiments of the present invention provide backlighting methods for a display screen that includes picture elements of different colors, by backlighting the display screen with at least one different color than the picture elements. In some embodiments, the display screen includes red, green and blue picture elements, and the at least one different color includes cyanine and/or amber colors. Analogous backlight system embodiments for a display screen that includes picture elements of different colors can provide at least one light source that is configured to radiate light of at least one different color than the picture elements in a light path that impinges on the display screen, to provide backlighting on the display screen.

### BRIEF DESCRIPTION OF THE DRAWINGS

FIGS. 1-3 are cross-sectional views of display panels according to various embodiments of the present invention.

### DETAILED DESCRIPTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout. As used herein the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, regions, steps, operations, elements, and/or components, but do not preclude the presence or addition of one or more other features, regions, steps, operations, elements, components, and/or groups thereof.

It will be understood that when an element, such as a layer or region, is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, components, regions, layers and/or sections, these elements, materials, regions, layers and/or sections should not be limited by these terms. These terms are only used to distinguish one element, material, region, layer or section from another element, material, region, layer or section. Thus, a first element, material, region, layer or section discussed below could be termed a second element, material, region, layer or section without departing from the teachings of the present invention.

Furthermore, relative terms, such as “lower”, “base”, or “horizontal”, and “upper”, “top”, or “vertical” may be used herein to describe one element's relationship to another element as illustrated in the Figures. It will be understood that relative terms are intended to encompass different orientations of the device in addition to the orientation depicted in the Figures. For example, if the device in the Figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below. Moreover, the terms “front” and “back” are used herein to describe opposing outward faces of a flat panel display. Conventionally, the viewing face is deemed the front, but the viewing face may also be deemed the back, depending on orientation.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated, typically, may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

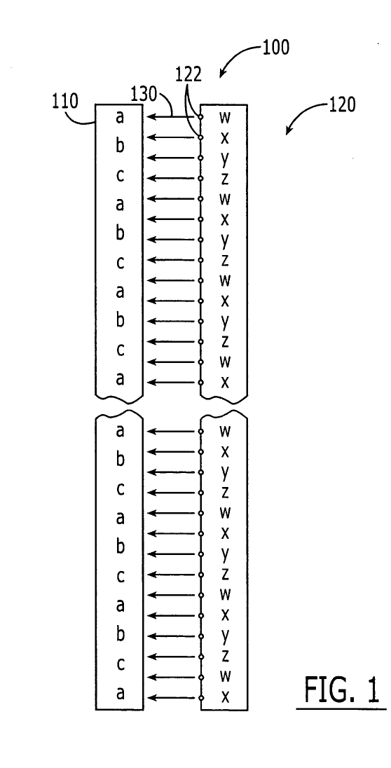

FIG. 1 is a cross-sectional view of display panels for flat panel displays that include backlight systems and methods according to various embodiments of the present invention. As shown in FIG. 1, these display panels 100 include a display screen 110 that includes a plurality of arrays of a respective plurality of different color picture elements, such as three arrays labeled a, b and c in the display screen 110. The design of a display screen 110 as described in this paragraph is well known to those having skill in the art and need not be described further herein.

Still referring to FIG. 1, a backlight system/method 120 for the display screen 110 includes a plurality of arrays of LED devices 122 of a respective plurality of different colors, such as four arrays labeled w, x, y and z in FIG. 1. The plurality of arrays of LED devices 122 of a respective plurality of different colors are configured to radiate light of the respective plurality of different colors in a light path 130 that impinges on the display screen 110 to provide backlighting on the display screen 110. It will be understood by those having skill in the art that the light path 130 is illustrated by parallel arrows for the sake of clarity, but that, conventionally, light from the various color LEDs mix in the mixing area between the LEDs and the display screen 110, to provide relatively uniform backlighting. The arrays of LED devices may be positioned to provide direct backlighting of the display as described, for example, in application Ser. No. 11/022,332, filed Dec. 23, 2004, entitled Light Emitting Diode Arrays For Direct Backlighting Of Liquid Crystal Displays, to coinventor Negley et al., and/or to provide edge backlighting of the display screen, as described in application Ser. No. 10/898,608, filed Jul. 23, 2004, entitled Reflective Optical Elements for Semiconductor Light Emitting Devices, to coinventor Negley, and/or in other conventional backlighting configurations. It will be understood that the arrays of LED devices w, x, y, z may have a smaller pitch than, a larger pitch than, or the same pitch as, the arrays of picture elements a, b and c.

As shown in FIG. 1, more arrays of different color LED devices 122 than arrays of different color picture elements 110 are provided. For example, three arrays of different color picture elements (a, b, c) and four arrays of LED backlight devices (w, x, y, z) may be provided. The four arrays of LED devices 122 (w, x, y, z) are configured to radiate light of a respective four colors, so as to create a perception of white light, in some embodiments. It has been found, according to embodiments of FIG. 1, that by increasing the number of arrays of backlighting LED devices compared to the number of different color picture elements, a changed color gamut and/or CRI may be provided. For example, the color gamut may be decreased, but the CRI may be increased. Other potential advantages may also be obtained.

FIG. 1 also illustrates embodiments of the present invention wherein a backlight system/method 120 for display screen 110 includes at least one light source that is configured to radiate light of more different colors than the picture elements, in a light path 130 that impinges on the display screen 110, to provide backlighting on the display screen. FIG. 1 also illustrates embodiments of the present invention wherein a backlight system/method 120 for display screen 110 includes at least one light source that is configured to radiate light of at least one different color than the picture elements in a light path 130 that impinges on the display screen 110, to provide backlighting on the display screen. In some embodiments, backlighting light sources other than LEDs, such as field emitter/phosphor arrays, may be used. Moreover, in some embodiments, multiple light sources may be embodied by a single array of light emitting devices with different color phosphors, to radiate backlighting light of more different colors than the different color picture elements.

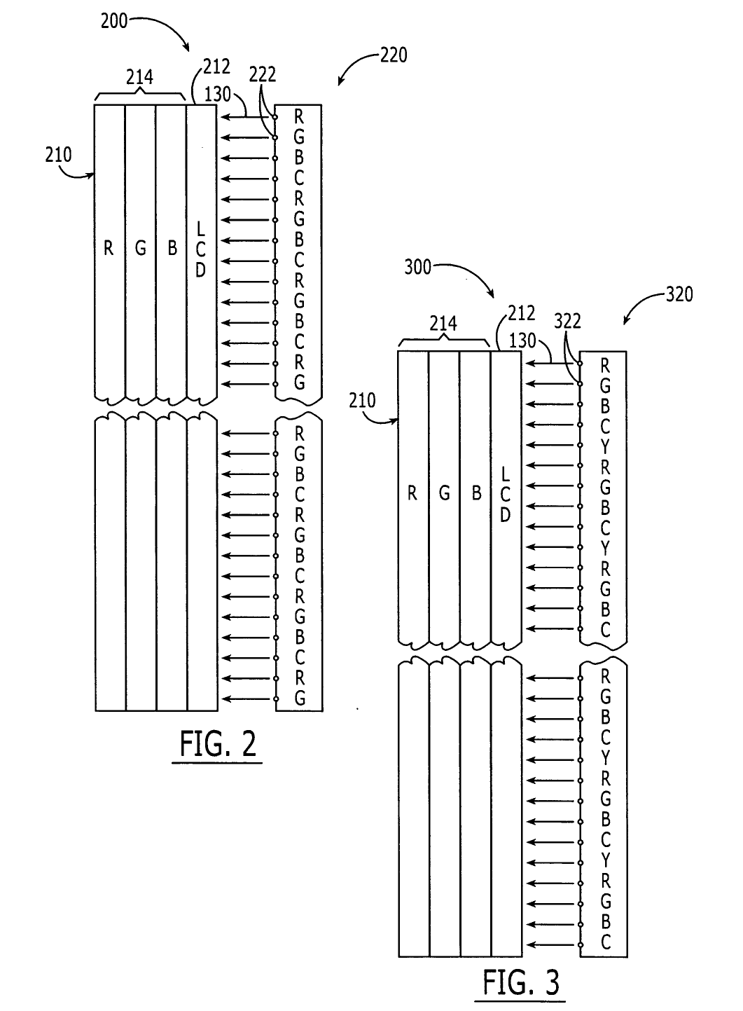

FIG. 2 is a block diagram of display panels according to other embodiments of the present invention. In these embodiments, the display screen 210 includes a two-dimensional array of LCD devices 212, and at least two color filters 214 thereon. In FIG. 2, three color filters 214R, 214G and 214B, corresponding to red, green and blue color filters, are shown. As is well known to those having skill in the art, the array of LCD devices 212 and the three color filters 214 define three arrays of three different color picture elements. The design of LCD devices 212 and color filters 214 as described in this paragraph are well known to those having skill in the art and need not be described further herein.

Still referring to FIG. 2, backlight systems and/or methods 220 include arrays of red, green, blue and cyanine LED devices 222R, 222G, 222B and 222C, respectively. In some embodiments, the red LEDs have a center frequency of about 625 nm, the green LEDs have a center frequency of about 535 nm, the blue LEDs have a center frequency of about 460 nm, and the cyanine LEDs have a center frequency of about 495 nm to about 505 nm. The color filters 214 do not include a cyanine color filter. Thus, there are more arrays of different color LED devices 222 than different color picture elements 214. By providing an additional array of cyanine backlighting LED devices 222C, according to embodiments of FIG. 2, the color gamut and/or CRI may be changed compared to an array of red, green and blue backlighting LED devices, while allowing a standard configuration of LCD devices 212 and color filters 214 to be maintained.

FIG. 3 is a side cross-sectional view of still other embodiments of the present invention. As shown in FIG. 3, these display panels 300 provide backlight systems/methods 320 that include arrays of red, green, blue, cyan and yellow (also referred to as amber) LED devices 322R, 322G, 322B, 322C, 322Y. By providing five different arrays of LED backlighting devices 322, the color gamut and/or CRI may be changed even further. In some embodiments, the yellow LEDs 322Y have a center frequency of about 570 nm. In yet other embodiments, four arrays of different color LEDs may be provided by arrays of red, green, blue and yellow LEDs.

FIGS. 1-3 also illustrate method embodiments of the present invention that can operate a display screen that includes a two-dimensional array of LCD devices, three different color filters thereon, and three arrays of LED devices that are configured to radiate light of a respective three different colors in a light path that impinges on the display screen, to provide backlighting that is perceived as white light on a display screen. These methods include adding at least a fourth array of LED devices that is configured to radiate light in a fourth color that is different from the three different colors, to continue to provide backlighting that is perceived as white light on a display screen. The fourth array may include cyanine or yellow LED devices. Arrays of cyanine and yellow LED devices also may be included. Moreover, in any of the embodiments of FIGS. 1-3, backlight sources other than LEDs (such as field emitters) may be used and/or shutterable displays other than LCDs (such as holographic optical elements) may be used. Backlighting methods for display screens that include picture elements of different colors, according to other embodiments of the present invention, include backlighting the display screen with more different colors than the picture elements.

It also will be understood by those having skill in the art that various combinations and subcombinations of embodiments of FIGS. 1-3 may be provided according to other embodiments of the present invention.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A backlight system for a display screen that includes a plurality of arrays of a respective plurality of different color picture elements, the backlight system comprising:
a plurality of arrays of different color Light Emitting Diode (LED) devices that are configured to radiate light of a respective plurality of different colors in a light path that impinges on the display screen to provide backlighting on the display screen that includes a plurality of arrays of a respective plurality of different color picture elements, wherein more arrays of different color LED devices than arrays of different color picture elements are provided.

2. A backlight system according to claim 1 wherein the plurality of arrays of a respective plurality of different color picture elements comprise three arrays of a respective three different color picture elements and wherein the plurality of arrays of different color LED devices comprise four arrays of four different color LED devices.

3. A backlight system according to claim 1 wherein the plurality of arrays of different color LED devices are configured to radiate light of a respective plurality of different colors so as to create a perception of white light.

4. A backlight system according to claim 2 wherein the four arrays of different color LED devices are configured to radiate light of a respective four different colors so as to create a perception of white light.

5. A backlight system according to claim 1 wherein the display screen that includes a plurality of arrays of a respective plurality of different color picture elements comprises a two-dimensional array of Liquid Crystal Display (LCD) devices including the respective plurality of different color filters thereon.

6. A backlight system according to claim 5 wherein the two-dimensional array of LCD devices includes red, blue and green color filters thereon and does not include a cyanine color filter thereon, and wherein the plurality of arrays of different color LED devices include arrays of red, green, blue and cyanine LED devices.

7. A backlight system according to claim 5 wherein the two-dimensional array of LCD devices includes red, blue and green color filters thereon and does not include a cyanine color filter or an amber color filter thereon, and wherein the plurality of arrays of different color LED devices include arrays of red, green, blue, cyanine and amber LED devices.

8. A display screen comprising a plurality of arrays of a respective plurality of different color picture elements and a backlight system according to claim 1.

9. A display screen comprising a two-dimensional array of LCD devices including the red, blue and green color filters thereon and a backlight system according to claim 5.

10. A method of operating a display panel that includes a display screen comprising a two-dimensional array of Liquid Crystal Display (LCD) devices and three different color filters thereon, and three arrays of Light Emitting Diode (LED) devices that are configured to radiate light of a respective three different colors in a light path that impinges on the display screen to provide backlighting that is perceived as white light on the display screen, the method comprising:
adding at least a fourth array of Light Emitting Diode (LED) devices that is configured to radiate light in a fourth color that is different from the three different colors, to continue to provide backlighting that is perceived as white light on the display screen.

11. A method according to claim 10 wherein the two-dimensional array of LCD devices includes red, blue and green color filters thereon, wherein the three arrays of LED devices include arrays of red, green and blue LED devices and wherein the at least a fourth array of LED devices includes a fourth array of cyanine LED devices.

12. A method according to claim 10 wherein the two-dimensional array of LCD devices includes red, blue and green color filters thereon, wherein the three arrays of LED devices include three arrays of red, green and blue LED devices and wherein the at least a fourth array of LED devices includes a fourth array of cyanine LED devices and a fifth array of amber LED devices.

13. A backlighting method for a display screen that includes picture elements of different colors, the backlighting method comprising:
backlighting the display screen with more different colors than the picture elements.

14. A method according to claim 13 wherein the display screen includes red, green and blue picture elements but does not include cyanine picture elements and wherein backlighting comprises backlighting the display screen with red, green, blue and cyanine colors.

15. A method according to claim 13 wherein the display screen includes red, green and blue picture elements but does not include cyanine or amber picture elements and wherein backlighting comprises backlighting the display screen with red, green, blue, cyanine and amber colors.

16. A method according to claim 13 wherein the picture elements include a two dimensional array of Liquid Crystal Display (LCD) devices and three different color filters thereon, and wherein the more different colors are generated by Light Emitting Diode (LED) devices of the more different colors than the picture elements.

17. A method according to claim 13 wherein the more different colors are generated by a plurality of light sources of the more different colors than the picture elements.

18. A method according to claim 13 wherein backlighting comprises backlighting the display screen with the more different colors than the picture elements to provide backlighting that is perceived as white light on the display screen.

19. A backlight system for a display screen that includes picture elements of different colors, the backlight system comprising:
at least one light source that is configured to radiate light of more different colors than the picture elements, in a light path that impinges on the display screen, to provide backlighting on the display screen.

20. A backlight system according to claim 19 wherein the picture elements of different colors comprise three different color picture elements and wherein the at least one light source radiates light of four different colors.

21. A backlight system according to claim 19 wherein the at least one light source is configured to radiate light of more different colors than the picture elements so as to create a perception of white light.

22. A backlight system according to claim 19 wherein the picture elements of different colors include red, blue and green picture elements but do not include cyanine picture elements, and wherein the more different colors than the picture elements include red, green, blue and cyanine colors.

23. A backlight system according to claim 19 wherein the picture elements of different colors include red, blue and green picture elements but do not include cyanine or amber picture elements, and wherein the more different colors than the picture elements include arrays of red, green, blue, cyanine and amber colors.

24. A display screen comprising picture elements of different colors and a backlight system according to claim 19.

25. A backlighting method for a display screen that includes picture elements of different colors, the backlighting method comprising:
backlighting the display screen with at least one different color than the picture elements.

26. A method according to claim 25 wherein the display screen includes red, green and blue picture elements but does not include cyanine picture elements and wherein backlighting comprises backlighting the display screen with cyanine color.

27. A method according to claim 25 wherein the display screen includes red, green and blue picture elements but does not include cyanine or amber picture elements and wherein backlighting comprises backlighting the display screen with cyanine and amber colors.

28. A backlight system for a display screen that includes picture elements of different colors, the backlight system comprising:
at least one light source that is configured to radiate light of at least one different color than the picture elements, in a light path that impinges on the display screen, to provide backlighting on the display screen.

29. A backlight system according to claim 28 wherein the picture elements of different colors include red, blue and green picture elements but do not include cyanine picture elements, and wherein the at least one different color than the picture elements includes cyanine color.

30. A backlight system according to claim 28 wherein the picture elements of different colors include red, blue and green picture elements but do not include cyanine or amber picture elements, and wherein the at least one different color than the picture elements include cyanine and amber colors.
